(19) United States
(12) Patent Application Publication
(10) Pub. No.: US 2024/0420173 A1
(43) Pub. Date: Dec. 19, 2024

(54) SERVICE MANAGEMENT APPARATUS, SERVICE MANAGEMENT METHOD, AND NON-TRANSITORY COMPUTER-READABLE STORAGE MEDIUM

(71) Applicant: NEC Corporation, Minato-ku, Tokyo (JP)

(72) Inventor: Tomoki INOUE, Tokyo (JP)

(73) Assignee: NEC Corporation, Minato-ku, Tokyo (JP)

(21) Appl. No.: 18/718,875

(22) PCT Filed: Dec. 27, 2021
(86) PCT No.: PCT/JP2021/048597

§ 371 Date: Jun. 12, 2024

(51) Int. Cl. G06Q 30/0207

(52) U.S. Cl. CPC G06Q 30/0224

(57) ABSTRACT

A service management apparatus (100) includes: a node that stores a rule (220) associating a usage history (210) of a service provided by each of a plurality of business entities with a providable incentive service; and a service processing unit (102) that, when acquiring the usage history (210) of the service provided by each of the plurality of business entities for a user, determines, by using the rule (220), an incentive service providable to the user and executes processing related to the determined incentive service.

### TECHNICAL FIELD

The present invention relates to a service management apparatus, a service management method, and a program.

### BACKGROUND ART

Patent Document 1 describes an example of a technology for promoting use of a service. A placement in Patent Document 1 includes: an acquisition unit that acquires a usage history in a predetermined accumulation period, the usage history being a usage history for a user in a predetermined service, and a usage history in a transaction period at least part of which overlaps the accumulation period; and a determination unit that determines, as a bonus provided to the user, a bonus based on a usage history of a service in the transaction period, the bonus varying according to a usage history in the accumulation period.

Further, Patent Document 2 describes a system that enables management of service information and a service for customer acquisition and sales promotion by providing, by using a customer-owned mobile information terminal, service information that can be used according to a usage track record of a card.

Further, Patent Document 3 describes an information provision apparatus that, in order to promote sale of a product or a service, causes a mobile terminal to display a coupon that can be used when the product or the service is purchased.

### RELATED DOCUMENTS

### Patent Documents

Patent Document 1: Japanese Patent Application Publication No. 2021-120843
Patent Document 2: Japanese Patent Application Publication No. 2004-227417
Patent Document 3: Japanese Patent Application Publication No. 2016-71649

### SUMMARY OF INVENTION

### Technical Problem

A technology for promoting use of a specific service is described in relation to provision of this service in the technology described in each of the aforementioned patent documents. None of the documents include a concept of promoting use of each service by freely combining services provided by a plurality of different business entities and awarding an incentive to a user according to a use condition of the services.

The present invention has been made in view of the aforementioned circumstances, and an object of the present invention is to promote service use by a user by freely combining services provided by a plurality of different business entities.

### Solution to Problem

In order to resolve the aforementioned issue, the following configurations are respectively employed in aspects of the present invention.

A first aspect relates to a service management apparatus.

A service management apparatus according to the first aspect includes:
a storage unit that stores a rule associating a usage history of a service provided by each of a plurality of business entities with a providable incentive service; and
a service processing unit that, when acquiring a usage history of the service provided by each of the plurality of business entities for a user, determines, by using the rule, an incentive service providable to the user and executes processing related to the determined incentive service.

A second aspect relates to a service management method executed by at least one computer.

A service management method according to the second aspect includes, by a service management apparatus:
storing, into a storage unit, a rule associating a usage history of a service provided by each of a plurality of business entities with a providable incentive service; and,
when acquiring a usage history of the service provided by each of the plurality of business entities for a user, determining, by using the rule, an incentive service providable to the user and executing processing related to the determined incentive service.

Note that another aspect of the present invention may be a program causing at least one computer to execute the method according to the aforementioned second aspect or a storage medium readable by a computer in which such a program is recorded. The storage medium includes a non-transitory tangible medium.

The computer program includes a computer program code causing a computer to execute the service management method on the service management apparatus when being executed by the computer.

Note that any combination of the components described above, and representations of the present invention converted between a method, an apparatus, a system, a storage medium, a computer program, and the like are also valid as embodiments of the present invention.

Further, various components of the present invention do not necessarily need to be individually independent, and for example, a plurality of components may be formed as a single member, a plurality of members may form a single component, a certain component may be part of another component, and part of a certain component may overlap with part of another component.

Further, while a plurality of procedures are described in a sequential order in the method and the computer program according to the present invention, the order of description does not limit the order in which the plurality of procedures are executed. Therefore, when the method and the computer program according to the present invention are executed, the order of the plurality of procedures may be changed without affecting the contents.

Furthermore, the plurality of procedures in the method and the computer program according to the present invention are not limited to be executed at timings different from each other. Therefore, for example, a certain procedure may be generated during execution of another procedure, and an execution timing of a certain procedure and an execution timing of another procedure may overlap with each other in part or in whole.

### Advantageous Effects of Invention

According to each of the aforementioned aspects, service use by a user can be promoted by freely combining services provided by a plurality of different business entities.

### BRIEF DESCRIPTION OF THE DRAWINGS

FIG. 1 It is a diagram conceptually illustrating a system configuration of a service management system according to an example embodiment of the present invention.

FIG. 2 It is a block diagram illustrating a hardware configuration of each computer constituting the service management system illustrated in FIG. 1.

FIG. 3 It is a functional block diagram illustrating a logical configuration of a service management apparatus according to the example embodiment.

FIG. 4 It is a flowchart illustrating an operation example of the service management apparatus according to the example embodiment.

FIG. 5 It is a diagram conceptually illustrating a system configuration of a service management system according to an example embodiment.

FIG. 6 It is a functional block diagram illustrating a logical configuration of a service management apparatus according to the example embodiment.

FIG. 7 It is a diagram illustrating an example of a data structure of a token.

FIG. 8 It is a diagram for illustrating pieces of token usage history information of tokens recorded in a plurality of nodes.

FIG. 9 It is a flowchart illustrating an operation example of a token processing unit in the service management apparatus according to the example embodiment.

FIG. 10 It is a flowchart illustrating an operation example of settlement processing by a service processing unit in the service management apparatus according to the example embodiment.

FIG. 11 It is a functional block diagram logically illustrating a configuration of a service management apparatus according to an example embodiment.

### EXAMPLE EMBODIMENT

Example embodiments of the present invention will be described below by using drawings. Note that in every drawing, similar components are given similar signs, and description thereof is not included as appropriate. Further, in each of the following diagrams, a configuration of a part not related to the essence of the present invention is not included and is not illustrated.

In the example embodiments, “acquisition” includes at least either of an apparatus getting data or information stored in another apparatus or storage medium (active acquisition), and an apparatus inputting data or information output from another apparatus to the apparatus (passive acquisition). Examples of the active acquisition include making a request or an inquiry to another apparatus and receiving a response, and readout by accessing another apparatus or storage medium. Further, examples of the passive acquisition include reception of distributed (or, for example, transmitted or push notified) information. Furthermore, “acquisition” may refer to selective acquisition from received data or information, or selective reception of distributed data or information.

### First Example Embodiment

### <System Overview>

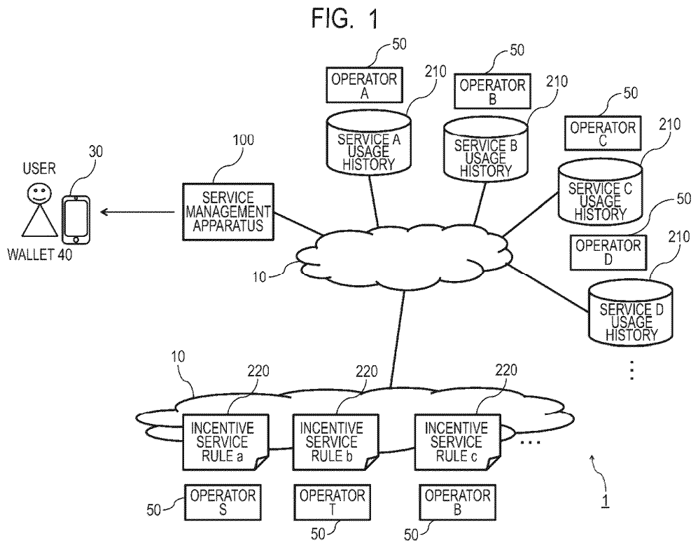

FIG. 1 is a diagram conceptually illustrating a system configuration of a service management system 1 according to an example embodiment of the present invention.

The service management system 1 manages provision of services to a user, the services being provided by a plurality of different business entities. The service management system 1 includes a storage apparatus that stores a service usage history 210 of a service provided by each of a plurality of business entities (indicated as operators 50 in the diagram) and a service management apparatus 100 that manages service usage histories 210 of the plurality of operators 50.

For example, the function of the service management apparatus 100 is provided by decentralized applications (dApps) operating on a distributed network. However, without being limited to the above, the function of the service management apparatus 100 may be provided by at least one server operating on a cloud.

Further, the service management apparatus 100 may be a computer managed by an organization such as a so-called optimizer or aggregator.

A menu provided to a user can be created by freely combining services provided respectively by a plurality of different operators 50, and a rule 220 awarding an incentive to the user on condition that a plurality of services included in the menu are used can be created. The rule 220 may be created by a separate business entity (such as an agent, a local self-governing body, or an event planning company) other than the operators 50 providing individual services.

A rule 220 may be created on an operation terminal (a computer 1000 to be described later) of a business entity.

Further, while details will be described in an example embodiment to be described later, service usage histories 210 and rules 220 are stored in nodes 20 (unillustrated in FIG. 1) on a block chain network 10. The service management apparatus 100 refers to a service usage history 210 stored in each node 20 on the block chain network 10.

### Hardware Configuration Example

Each of a plurality of nodes 20 and the service management apparatus 100 constituting the service management system 1 is implemented by at least one computer. Further, a user terminal 30 of a user is a smartphone, a tablet terminal, a wearable terminal, or the like and is also implemented by a computer. Further, as described above, an operation terminal of a business entity is a personal computer, a smartphone, a tablet terminal, or the like and is also implemented by a computer.

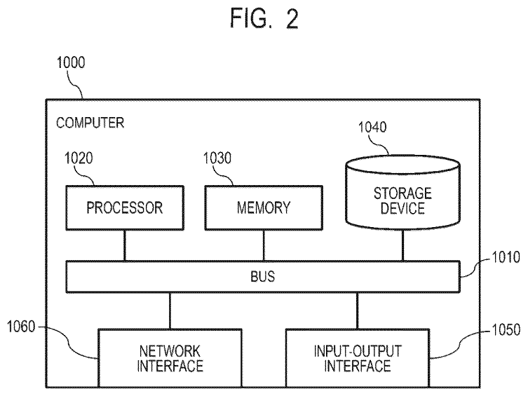

FIG. 2 is a block diagram illustrating a hardware configuration of each computer 1000 constituting the service management system 1 illustrated in FIG. 1.

The computer 1000 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from each other. Note that the method for interconnecting the processor 1020 and other components is not limited to a bus connection.

The processor 1020 is a processor implemented by a central processing unit (CPU), a graphics processing unit (GPU), or the like.

The memory 1030 is a main storage implemented by a random-access memory (RAM) or the like.

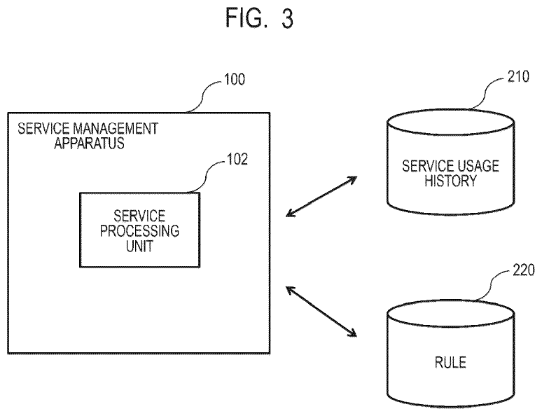

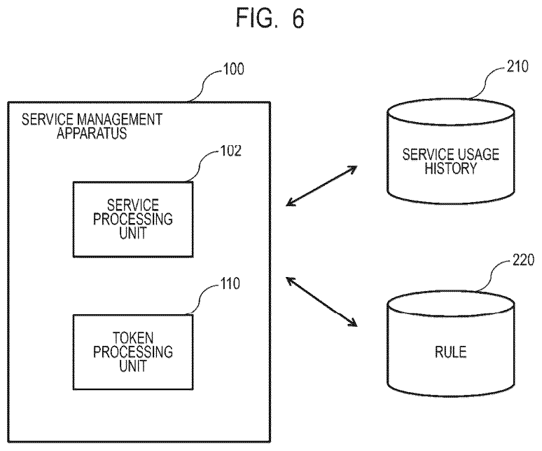

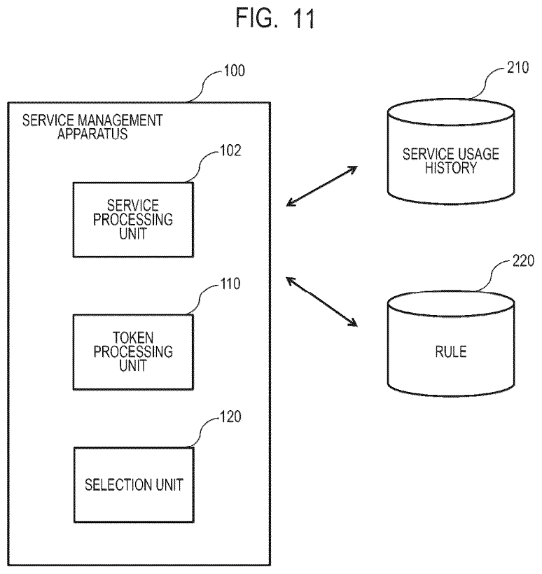

The storage device 1040 is an auxiliary storage implemented by a hard disk drive (HDD), a solid-state drive (SSD), a memory card, a read-only memory (ROM), or the like. The storage device 1040 stores a program module providing each of the functions of the service management apparatus 100 (such as, a service processing unit 102 in FIG. 3, a token processing unit 110 in FIG. 6, a selection unit 120 in FIG. 11, and the like that will be described later) in the service management system 1. By reading each program module into the memory 1030 and executing the program module by the processor 1020, each function related to the program module is provided. Further, the storage device 1040 also functions as a storage unit (unillustrated) that stores various types of information used by the service management apparatus 100. Further, a storage unit in a node 20 may also be implemented by the storage device 1040.

A program module may be recorded on a storage medium. The storage medium on which the program module is recorded includes a non-transitory tangible medium that can be used by the computer 1000, and a program code readable by the computer 1000 (the processor 1020) may be embedded in the medium.

The input-output interface 1050 is an interface for connecting the computer 1000 to various types of input/output equipment.

The network interface 1060 is an interface for connecting the computer 1000 to a communication network. Examples of the communication network include a local area network (LAN) and a wide area network (WAN). The method for connecting the network interface 1060 to the communication network may be a wireless connection or a wired connection. Note that the network interface 1060 may not be used.

Then, the computer 1000 is connected to unillustrated necessary equipment (such as a camera, a display, an operation unit, and/or a touch panel) through the input-output interface 1050 or the network interface 1060. Alternatively, the computer 1000 communicates with any unillustrated piece of equipment (such as an automatic ticket gate or an IC card reader) through the input-output interface 1050 or the network interface 1060.

The service management system 1 may be implemented by a plurality of computers 1000 constituting the service management apparatus 100.

Each component in a service management apparatus 100 according to each example embodiment to be described later illustrated in FIG. 3, FIG. 6, or FIG. 11 is implemented by any combination of hardware and software of the computer 1000 in FIG. 2. Then, it may be understood by a person skilled in the art that various modifications to the providing method and the apparatus can be made. A functional block diagram illustrating the service management apparatus 100 according to each example embodiment illustrates logical function-based blocks rather than a hardware-based configuration.

### Functional Configuration Example

FIG. 3 is a functional block diagram illustrating a logical configuration of the service management apparatus 100 according to the present example embodiment.

The service management apparatus 100 includes the service processing unit 102.

First, a rule 220 associating a usage history 210 of a service provided by each of a plurality of business entities with a providable incentive service is stored in a node 20. A service usage history 210 is recorded into a node 20 each time a user uses a service provided by each operator 50. Further, an awarding condition of an incentive based on a use condition of a service is defined in a rule 220 by an operator 50 or the like. As described above, a rule 220 may be defined by an operator 50 other than an operator 50 providing the service.

According to the present example embodiment, service usage histories 210 and rules 220 are stored in a plurality of nodes 20 on the block chain network 10. Therefore, a person other than an operator 50 providing the service may define a rule 220 and store the rule into a node 20 by using an external operation terminal (implemented by the computer 1000 in FIG. 2).

For example, a rule 220 can be defined by description in a predetermined programming language by using an operation terminal of an operator 50. For example, a rule 220 includes discount logic and incentive logic. Further, an application for setting a rule 220 may be provided. A rule 220 may be created by launching the application on an operation terminal of an operator 50 and operating, by the operator, a screen including various user interfaces accepting selection of a service to be set in a use condition, specification of a use condition, specification of the type of incentive and an awarding means, and the like.

The created rule 220 is stored in a node 20 on the block chain network 10. A plurality of rules 220 may be provided to the user by, for example, being disclosed on a website or the like as a service list. Details will be described in a third example embodiment to be described later.

A service usage history 210 at least includes identification information for identifying a user (a user ID), identification information for identifying a service being used (a service ID), and date and time information when the service is used.

The service processing unit 102 acquires at least one rule 220 out of rules 220 stored in a plurality of nodes 20. Furthermore, the service processing unit 102 extracts and acquires a service usage history 210 related to a user out of service usage histories 210 stored in a plurality of nodes 20 with, for example, the user ID of the user as a search key.

For example, a rule 220 can be created by combining at least two services out of services related to use of a transportation system, purchase of an article, and use of a lodging facility. A rule 220 includes the service ID of a target service, and discount logic or incentive logic. Further, a rule 220 may include a period in which the rule 220 is applied as a condition. Alternatively, a rule 220 may include an attribute (such as a student, a senior, a family with a child, or gender) or the like of a user being an application target of the rule 220 as a condition. Specific examples of a rule 220 will be described later in examples.

When acquiring a usage history 210 of a service by each of a plurality of operators 50 about a user, the service processing unit 102 determines, by using a rule 220, an incentive service providable to the user and executes processing related to the determined incentive service.

Processing related to an incentive service refers to awarding of a predetermined value to a user and is, for example, processing electronically performing a discount on a fee, a cash rebate, point awarding, coupon distribution, or the like. The service processing unit 102 executes value awarding to a user. For example, in a case of coupon distribution, the service processing unit 102 registers a digital coupon in a wallet 40 on a user terminal 30 of a user. Other types of processing will be described in detail in a second example embodiment to be described later.

### Operation Example

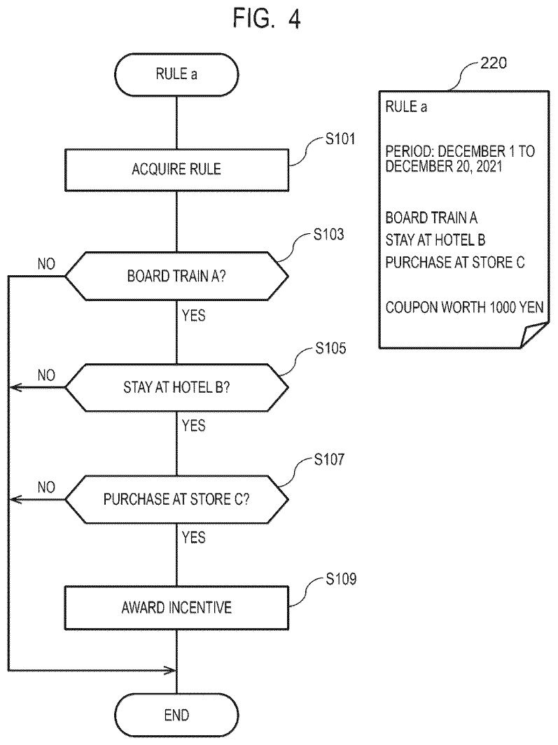

FIG. 4 is a flowchart illustrating an operation example of the service management apparatus 100 according to the present example embodiment.

First, the service processing unit 102 acquires a rule a defining that a coupon worth 1000 yen is awarded on condition of boarding on a train A, lodging at a hotel B, and purchase at a store C in a specific period of use (Step S101). Acquisition of a rule 220 will be described in detail in the third example embodiment to be described later.

The service processing unit 102 refers to a service usage history 210 for a user in the specific period of use and determines whether each condition defined in the rule a is satisfied. Specifically, the service processing unit 102 first refers to the service usage history 210 for the user in the specific period of use and when being able to confirm boarding on the train A (YES in Step S103), advances to Step S105. When not being able to confirm boarding on the train A (NO in Step S103), this processing is ended.

Next, the service processing unit 102 refers to the service usage history 210 for the user in the specific period of use and when being able to confirm lodging at the hotel B (YES in Step S105), advances to Step S107. When not being able to confirm lodging at the hotel B (NO in Step S105), this processing is ended. Next, the service processing unit 102 refers to the service usage history 210 for the user in the specific period of use and when being able to confirm purchase at the store C (YES in Step S107), advances to Step S109. When not being able to confirm purchase at the store C (NO in Step S107), this processing is ended.

Note that the execution order of Step S103 to Step S107 is not limited to the above. For example, determination processing in the steps may be performed in parallel, the logical conjunction of the determination results may be found, and Step S109 may be executed when every determination result indicates YES.

In Step S109, the service processing unit 102 performs awarding of an incentive defined in the rule a which is distribution of a coupon worth 1000 yen in this case. Specifically, for example, a digital coupon worth 1000 yen is registered in the wallet 40 on the user terminal 30 of the user.

As described above, according to the present example embodiment, a rule 220 associating a usage history of a service provided by each of a plurality of business entities with a providable incentive service is stored in a node 20, and when acquiring a service usage history 210 of a service provided by each of the plurality of business entities for a user, the service processing unit 102 determines, by using the rule 220, an incentive service providable to the user and executes processing related to the determined incentive service. Thus, the present example embodiment enables services provided by a plurality of different business entities to be freely combined and be provided to a user along with awarding information of an incentive as a rule 220 and therefore enables promotion of service use by the user.

A plurality of operators 50 providing services do not need to manage a usage history for a user related to awarding of an incentive or execute processing related to awarding of an incentive and therefore can operate efficiently. On the other hand, the plurality of operators 50 providing services can acquire a service usage history 210 related to service use by a user and therefore can use the information in planning and sale of a future service.

### Second Example Embodiment

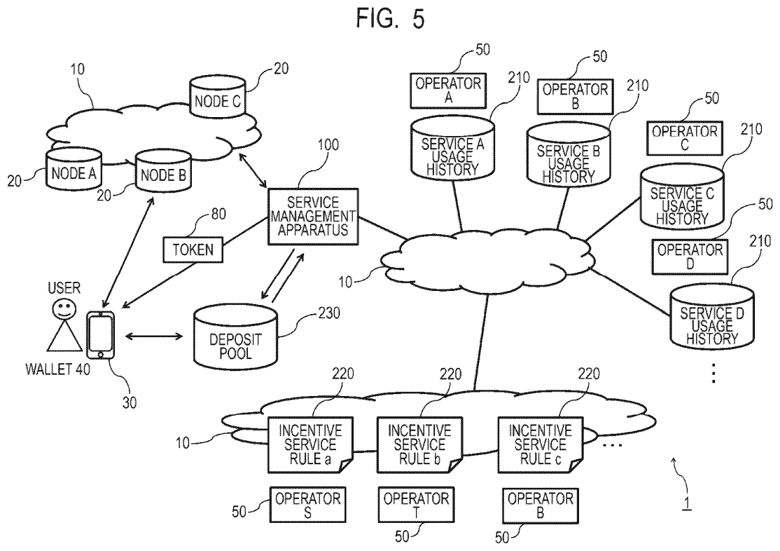

FIG. 5 is a diagram conceptually illustrating a system configuration of a service management system 1 according to the present example embodiment. The present example embodiment is similar to the aforementioned example embodiment except for being configured to use a token for use management of a service.

At least one token 80 is issued for each service provided to a user. For example, an application (such as a wallet 40) for registering a token 80 for a service to be used is preinstalled on a user terminal 30. A predetermined value used for payment related to a service is registered in the wallet 40 in advance in a usable manner. The predetermined value is defined in a virtual currency. While the virtual currency is not particularly limited, examples thereof include

### Bitcoin and Ethereum.

A user deposits an asset value into a deposit pool 230 in advance in a virtual currency by using the wallet 40. The deposited virtual currency is used in payment processing of a price to be paid when a service is used.

For example, a token 80 is a non-fungible token (NFT). A usage history of a token 80 related to a service is recorded into a node 20 on a block chain network 10 for each use of the service.

FIG. 6 is a functional block diagram illustrating a logical configuration of a service management apparatus 100 according to the present example embodiment. The service management apparatus 100 further includes a token processing unit 110 in addition to the configuration of the service management apparatus 100 in FIG. 3.

The token processing unit 110 is configured to issue a token 80 for a service, assign the token 80 to a user, and release the assignment of the token 80 issued to the user when provision of the service is ended.

A service processing unit 102 is configured to determine a usage history of a service for each user by using a usage history of a token 80.

A token 80 issued to a user is registered in the wallet 40 on the user terminal 30 of the user. A token 80 is issued for each service and, for example, is registered in the wallet 40 as a boarding ticket of a train or a lodging ticket of a hotel. Further, as for use of a service for purchasing an article at a store, a token 80 for a service for using payment by a virtual currency deposited in advance may be issued and be registered in the wallet 40.

Each time a service related to a token 80 issued to a user is used, the token processing unit 110 records identification information of the used token 80 (a token ID) and a date and time of use of the service into a node 20. For example, pieces of date and time information indicating when the user boards a train, when the user disembarks from the train, when the user checks into a hotel, when the user checks out from the hotel, and when the user uses virtual currency payment for purchase of a product at a store are respectively recorded into a node 20 as usage histories of the token 80.

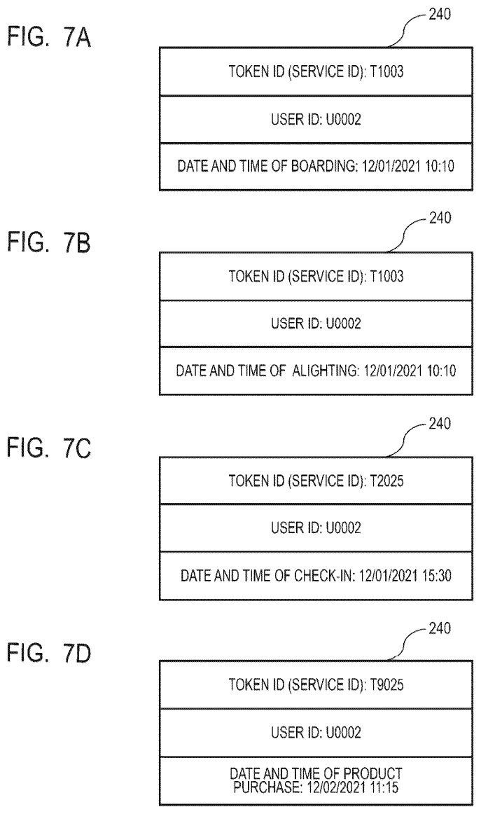

FIG. 7 is a diagram illustrating an example of a data structure of a token 80. The diagram is an example of token usage history information 240 recorded each time a token 80 is used. Token usage history information 240 at least includes a token ID, a user ID, and a date and time of use in association with each other.

In FIG. 7(a), date and time information when a user boards a train is stored in a node 20 in association with a token ID and a user ID. In FIG. 7(b), date and time information when the user disembarks from a train is stored in the node 20 in association with a token ID and the user ID. In FIG. 7(c), date and time information when the user checks into a hotel where the user stays is stored in the node 20 in association with a token ID and the user ID. In FIG. 7(d), date and time information when the user purchases a product at a store is stored in the node 20 in association with a token ID and the user ID.

When the token processing unit 110 issues a token 80, the token ID of the token 80 is stored in a service usage history 210 in association with the user ID of a user to whom the token 80 is issued and the service ID of a service usable with the token 80. Therefore, the token processing unit 110 can determine a service used by the token 80 by searching the service usage history 210 recorded in the node 20 for a related service ID with the token ID of the token 80 as a key.

Note that, while the token processing unit 110 records the token ID of a token 80 into token usage history information 240 each time the token 80 is used in the example in FIG. 7, the token processing unit 110 may record the service ID of a service usable with the token 80 into the token usage history information 240 in another example. In other words, the token processing unit 110 records at least one of the token ID of a token 80 and the service ID of a service provided by the token 80 into token usage history information 240 in association with a user ID and a date and time of use.

There are various conceivable methods for acquiring the token ID of a token 80 registered in the wallet 40 when the token 80 is used. For example, by the user terminal 30 communicating with an automatic ticket gate at a station, or a contactless IC card reader at a lodging facility or a store by short-distance wireless communication such as near-field communication (NFC), token usage history information 240 is recorded into a node 20 by the wallet 40 when a token 80 registered in the wallet 40 is used.

As another method for acquiring the token ID of a token 80, for example, a token 80 registered in the wallet 40 may be used by displaying a two-dimensional code [such as a quick response (QR) code (registered trademark)] including information about a service provided by the token 80 (a token ID or a service ID) and a user ID on a display of the user terminal 30 and reading the code with a barcode reader at a lodging facility or a store.

For example, a user ID may be user identification information in a registration for use in the wallet 40 or user identification information in a registration of a virtual currency for use and is not particularly limited. Note that it is assumed that consent of a user is previously acquired in acquisition of a user ID.

Since token usage history information 240 includes the user ID of a user, the service processing unit 102 can acquire a service usage history 210 for the user by extraction with the user ID as a key. Further, since the token usage history information 240 includes a date and time of use of the service, the service processing unit 102 can determine a service usage history 210 for the user in a period of use defined in a rule 220.

Furthermore, since token usage history information 240 includes a token ID related to a service, information about use of a service defined in a rule 220 can be extracted from a service usage history 210 of each operator 50 with a service ID as a key.

Further, in FIG. 5, a service usage history 210 for each service provided by an operator 50 can be acquired by extraction from token usage history information 240 indicating usage status of tokens 80 recorded in a plurality of nodes 20 in a distributed manner with a service ID as a key.

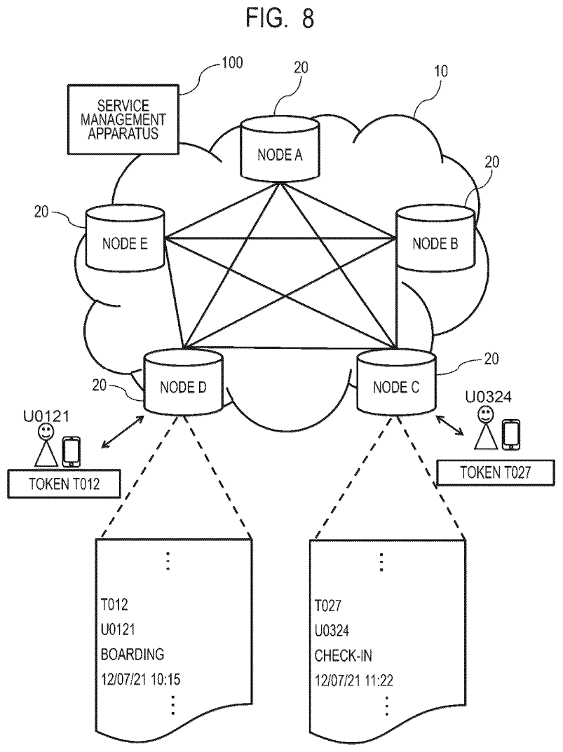

FIG. 8 illustrates a scene in which pieces of information of tokens 80 assigned to respective users are recorded in a plurality of nodes 20.

As described above, the token ID of a token 80 assigned to a user, the user ID, and a date and time of use are recorded and accumulated into each node 20 in the block chain network at each use. Records of service use by a certain user such as boarding of and disembarkation from a train, check-in and checkout at a hotel, and payment for product purchase at a store may be separately recorded into different nodes 20. Usage records of tokens 80 recorded in a plurality of nodes 20 in a distributed manner, that is, usage records of various services are managed by the service management apparatus 100 in an integrated manner. Therefore, the service processing unit 102 can determine a usage history of each token 80, that is, a usage history of a service.

According to the present example embodiment, a history of a token 80 can be recorded on the block chain network 10, and therefore, for example, even usage records of services provided by different operators 50 can be collectively managed by the service management system 1 by introducing the mechanism of the service management system 1. For example, usage status of a service across different operators 50 can be managed. Therefore, awarding of an incentive such as a discount on a service use fee on condition of use of a specific transportation system, use of a specific lodging facility, and purchase at a specific store in a tie-up campaign or the like planned by different operators 50 can be defined in a rule 220.

Note that information other than that in FIG. 7 may be considered as information recorded in association with a token 80. For example, in addition to a date and time of boarding of a boarding ticket of a train and a date and time of disembarkation, information indicating a station of boarding and a station of disembarkation may be recorded in association with a token 80. Alternatively, in addition to a date and time of product purchase, when a specific product is purchased, information indicating the product code of the product and a purchased amount may be recorded in association with a token 80. Alternatively, positional information of a user when a service is used may be acquired by using a position acquisition function of the user terminal 30 and usage position information may be recorded in association with a token 80. In other words, in addition to a token ID, a user ID, and a date and time of use, token usage history information 240 may further include at least one item out of a station of boarding, a station of disembarkation, a purchased product code, a purchased amount, service usage position information, and the like.

### Operation Example

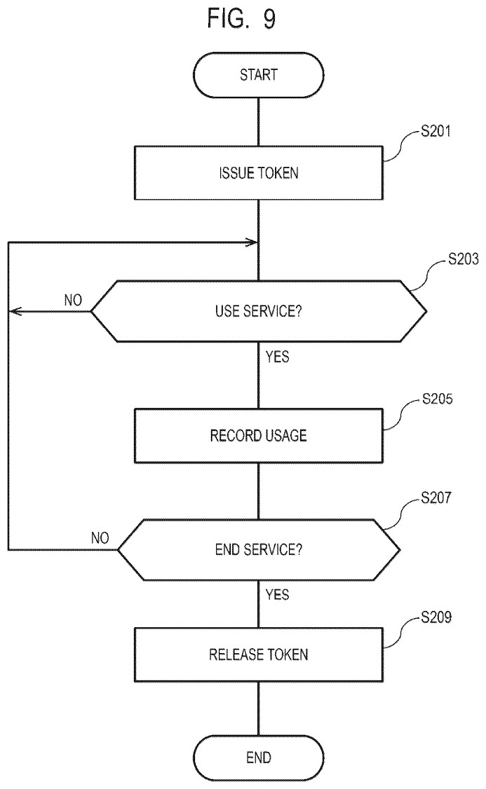

FIG. 9 is a flowchart illustrating an operation example of the token processing unit 110 in the service management apparatus 100 according to the present example embodiment.

First, when accepting selection of a service to be used by a user, the token processing unit 110 issues a token 80 related to use of the service and registers the token 80 in the wallet 40 on the user terminal 30 of the user (Step S201).

The token processing unit 110 stores the token ID of the token 80 issued to the user, the service ID of the service, the user ID of the user, and a date and time of issuance of the token 80 into token usage history information 240 in association with each other.

Then, when detecting use of the service by the user (YES in Step S203), the token processing unit 110 records information about use of the token 80 stored in a node 20 on the block chain network 10 (Step S205).

For example, use of a service by a user can be detected by using a record of entry into or exit from an automatic ticket gate using the wallet 40 on the user terminal 30. Alternatively, use of a service by a user can be detected by acceptance of a check-in operation of an airline ticket using the wallet 40 on the user terminal 30 at a check-in machine at an airport. Alternatively, use of a service by a user can be detected by use of the token 80 using the wallet 40 (such as readout of a two-dimensional barcode) at the time of checking into or checking out of a lodging facility. Alternatively, use of a service by a user can be detected by electronic payment processing at the time of purchase of a product using the wallet 40 at a store.

Specifically, at least the token ID of the token 80, the user ID of the user, and a date and time of use are recorded into a node 20 on the block chain network 10 as token usage history information 240.

Then, when detecting the end of use of the service (YES in Step S207), the token processing unit 110 releases the token 80 assigned to the user (Step S209). The method for detecting the end of use of a service may vary for each service. For example, in a case of a token 80 related to a boarding ticket of a train, when an exit record using the wallet 40 on the user terminal 30 at an automatic ticket gate at the time of disembarkation is accepted after boarding on the train, the end of use of the token 80 may be detected.

In a case of a token 80 for a service used at a lodging facility, the end of use of the service may be detected by acceptance of the end of use using the wallet 40 (such as readout of a two-dimensional barcode) at the time of checking out of the lodging facility. Alternatively, in a case of a token 80 related to purchase of a product at a store, for example, the end of use of the service may be detected by providing a time limit for use of the token 80 and detecting expiration of the time limit for use. Alternatively, the end of use of the token 80 may be detected by operating the wallet 40 and deleting the token 80 by the user himself/herself.

The token 80 assignment of which to the user is released is deleted from the wallet 40 on the user terminal 30 of the user. Alternatively, the token 80 may be recorded into the wallet 40 as a used token 80.

A usage history of a service is recorded into a node 20 each time a token 80 is used. The service management apparatus 100 can compile records of tokens 80 for services recorded in a plurality of nodes 20 in a distributed manner and can extract and manage the records as token usage history information 240 for each user or a service usage history 210 for each service. In other words, a service usage history 210 and token usage history information 240 are that are extracted for each service provided by each operator 50 and for each user, respectively, from usage records of tokens 80 recorded into a plurality of nodes 20 in a distributed manner at each use.

Note that the flowchart in FIG. 9 includes three types of processing, that is, issuance processing of a token 80 (Step S201), processing during service use (Step S203 to Step S205), and processing at the end of service use (Step S207 to Step S209). While the three types of processing are illustrated in such a way as to be executed in a sequential order for the sake of description in FIG. 9, the three types of processing can be individually executed, and do not necessarily be executed in a sequential order as illustrated in the flowchart in FIG. 9.

Next, by using a thus recorded service usage history 210 (token usage history information 240), the service processing unit 102 performs settlement processing of a value related to payment of a price for use of a service used by the user and settlement processing of a value accompanying awarding of an incentive.

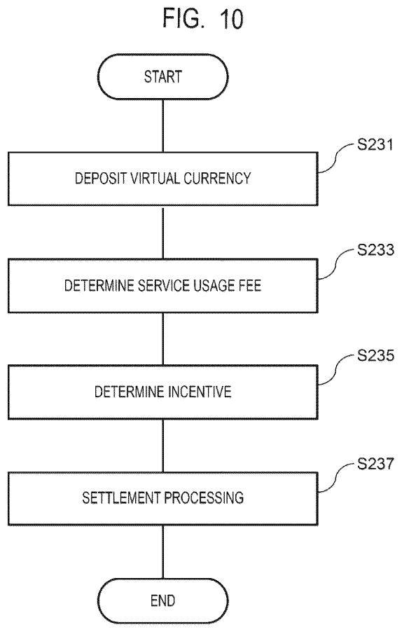

FIG. 10 is a flowchart illustrating an operation example of the settlement processing by the service processing unit 102 in the service management apparatus 100 according to the present example embodiment.

First, the service processing unit 102 accepts deposit of a virtual currency to the wallet 40 on the user terminal 30 of a user by the user (Step S231). The accepted virtual currency is stored into the deposit pool 230.

Then, when use of a service using the wallet 40 is detected, the service processing unit 102 determines a fee related to use of the service (Step S233). As for a fee related to use of each service, the service processing unit 102 may use a fee provided by an operator 50 providing the service or may inquire of the operator 50 providing the service about a fee for use when service use is accepted and acquire information about a value of service compensation at that point.

Next, it refers to a service usage history 210 for the user and determines an incentive awarded to the user in accordance with a use condition defined in a rule 220 (Step S235). For example, when a 10% discount on a usage fee upon satisfaction of the use condition in the rule 220 is defined, the service processing unit 102 applies the discount determined in Step S235 and performs the settlement processing at an amount acquired by applying a 10% price discount on the usage fee determined in Step S233. Specifically, it settles a value equivalent to the usage fee from the virtual currency of the user deposited in Step S231 and distributes the amount among operators 50 providing the services.

According to the present example embodiment, the token processing unit 110 issues a token 80 for a service, assigns the token 80 to a user, and releases the assignment of the token 80 issued to the user when provision of the service ends, and the service processing unit 102 determines a usage history of a service for each user by using a usage history of a token 80. Thus, by managing use of a service with a token 80, usage status by users of services provided by a plurality of different business entities can be efficiently indicated and be centrally managed by the service management apparatus 100.

Awarding processing of an incentive on condition of service use can be efficiently performed by settlement processing, by using a virtual currency with a service usage fee.

### Third Example Embodiment

FIG. 11 is a functional block diagram logically illustrating a configuration of a service management apparatus 100 according to the present example embodiment. The service management apparatus 100 according to the present example embodiment is similar to either one of the aforementioned example embodiments except for being configured to select a rule 220 applied to a user.

According to the present example embodiment, a selection unit 120 is further included in the configuration according to the second example embodiment in FIG. 6. Note that the selection unit 120 according to the present example embodiment may be combined with the configuration according to the first example embodiment in FIG. 3.

The selection unit 120 is configured to select at least one rule 220 out of a plurality of rules 220. A service processing unit 102 uses the selected rule 220.

While there are various conceivable methods for selecting a rule applied to a user by the selection unit 120 and examples of the method are described below, the method is not limited thereto. A plurality of methods described below may be combined.
(1) When a service category (such as travel, sport, or theatergoing) is selected, a list of rules 220 registered under the category is provided (displayed on a display of a user terminal 30), and user selection is accepted.
(2) A rule 220 optimum for a user is created, based on an attribute (such as the gender, the age, the occupation, a residential area, or a hobby) of the user, and is proposed to the user. The rule 220 may be created by a manager of a business entity or may be automatically created by predetermined logic (such as an application).
(3) At least one item out of an attribute of a user, a history of a service used by the user in the past, information about a service registered by the user in advance as a service of interest, and the like is learned by machine learning, and a rule 220 optimum for the user is created and is proposed to the user.
(4) A business entity proposes it to a specific user or public. For example, a business entity notifies it to the user terminal 30 of a user with a past usage history or publicly notifies it by a general advertisement or direct mail. The business entity may be either one of an operator 50 providing a service and a business entity not providing a service.

A timing for selection of a rule 220 by the selection unit 120 may be before settlement processing after use of a service, before use of the service, during use of the service, or in a specific period (such as a campaign period) and is not particularly limited.

According to the present example embodiment, the selection unit 120 selects at least one rule 220 out of a plurality of rules 220, and the service processing unit 102 uses the selected rule 220. The configuration enables proper provision of a service suited to a user to the user from an incentive service menu awarding an incentive to the user on condition of use of freely combined services provided by various business entities. Thus, use of services can be further promoted.

While the example embodiments of the present invention have been described above with reference to the drawings, the example embodiments are exemplifications of the present invention, and various configurations other than those described above may be employed.

For example, in use of each service provided by the service management system 1, a balance of a deposit of an asset of a user in the deposit pool 230 or a past track record may be set as a condition.

For example, the service processing unit 102 performs processing of displaying, on the wallet 40, a screen prompting depositing of an asset value before a user registers a service for use or determining whether a balance of the asset value of the user satisfies a criterion. For example, the criterion for a balance is that a value equal to or greater than a value required for service use is deposited in the deposit pool 230.

The configuration enables a value required as compensation of service use to be previously deposited and therefore enables collection of the value of the compensation of the service use to be securely performed.

### Examples

Examples indicating combination examples of services provided by a plurality of different business entities will be described below.

### Example 1

### <Regional Development or Travel Campaign>

An incentive service rule allowing a discount or a cash rebate by use of a transportation system in a specific region, product purchase at a product exhibition, and use of a lodging facility is defined.

Specifically, the following rule 220 is defined.
(a1) By boarding a specific bus a predetermined times or more, a fixed fee is applied (by a cash rebate for the difference or the like) (a service like a one-day boarding ticket).
(a2) By staying at a specific lodging facility, a token 80 equivalent to a predetermined amount is distributed at the time of product purchase at a neighboring product exhibition (a service like a region-wide coupon).
(a3) A 30% discount on an airfare for long-distance travel and a lodging facility usage fee is applied in a predetermined period.

### Example 2

### <Touring Campaign/Event Such as Stamp Rally>

An incentive service rule allowing enjoyment of an incentive (such as an NFT or a fungible token) and/or a discount when a tour around specific facilities is performed is defined. Specifically, the following rule 220 is defined.
(b1) An incentive is awarded when a tour around all stations in a predetermined railroad line in a specific period is performed.
(b2) An incentive is awarded when a tour around all specified popular tourist sites (such as a hot spring facility, and shrines and temples) in a specific region is performed.

### Example 3

### <Discount Service Across Transportation Companies>

An incentive service rule allowing a cash rebate for a difference or the like when a certain condition such as a certain number of times or more uses in a period across specific lines and a plurality of operators is defined.

Specifically, the following rule 220 is defined.
(c1) When a railroad and a taxi are used in parallel a predetermined number of times or more, a fixed fee is applied by collectively performing a cash rebate for the difference (a service like a commuter pass).
(c2) When long-distance travel by train is accompanied, the fee for travel by bus in a forward direction from the destination station is discounted.

While the present invention has been described with reference to the example embodiments and the examples thereof, the present invention is not limited to the aforementioned example embodiments and examples thereof. Various changes and modifications that may be understood by a person skilled in the art may be made to the configurations and details of the present invention within the scope of the present invention.

Note that when information about a user is acquired and used in the present invention, the acquisition and the use are assumed to be performed legally.

The whole or part of the example embodiments disclosed above may also be described as, but not limited to, the following supplementary notes.

1. A service management apparatus including:
a storage unit that stores a rule associating a usage history of a service provided by each of a plurality of business entities with a providable incentive service; and
a service processing unit that, when acquiring a usage history of the service provided by each of the plurality of business entities for a user, determines, by using the rule, an incentive service providable to the user and executes processing related to the determined incentive service.

2. The service management apparatus according to 1., wherein
the service includes at least two items out of use of a transportation system, purchase of an article, and use of a lodging facility.

3. The service management apparatus according to 1, or 2., wherein
the incentive service is awarding of a predetermined value to the user, and
the service processing unit executes awarding of the value to the user.

4. The service management apparatus according to 3., wherein
the predetermined value is defined in a virtual currency.

5. The service management apparatus according to any one of 1. to 4., wherein
a token is set to the service,
the service management apparatus further includes a token processing unit that issues a token for the service, assigns the token to a user, and releases assignment of the token issued to the user when provision of the service ends, and
the service processing unit determines a usage history of the service for the each user by using a usage history of the token.

6. The service management apparatus according to 5., wherein
the token is a non-fungible token (NFT).

7. The service management apparatus according to any one of 1. to 6., further including
a selection unit that selects at least one rule out of a plurality of the rules, wherein
the service processing unit uses the selected rule.

8. A service management method including, by a service management apparatus:
storing, into a storage unit, a rule associating a usage history of a service provided by each of a plurality of business entities with a providable incentive service; and,
when acquiring a usage history of the service provided by each of the plurality of business entities for a user, determining, by using the rule, an incentive service providable to the user and executing processing related to the determined incentive service.

9. The service management method according to 8., wherein
the service includes at least two items out of use of a transportation system, purchase of an article, and use of a lodging facility.

10. The service management method according to 8, or 9., wherein
the incentive service is awarding of a predetermined value to the user, and
the service management method further includes, by the service management apparatus, executing awarding of the value to the user.

11. The service management method according to 10., wherein
the predetermined value is defined in a virtual currency.

12. The service management method according to any one of 8. to 11., wherein
a token is set to the service, and
the service management method further includes, by the service management apparatus:
   issuing a token for the service, assigning the token to a user, and releasing assignment of the token issued to the user when provision of the service ends; and
   determining a usage history of the service for the each user by using a usage history of the token.

13. The service management method according to 12., wherein
the token is a non-fungible token (NFT).

14. The service management method according to any one of 8. to 13., further including, by the service management apparatus:
selecting at least one rule out of a plurality of the rules; and
determining the incentive service providable to the user by using the selected rule and executing processing related to the determined incentive service.

15. A program for causing a computer to execute:
a procedure for storing, into a storage unit, a rule associating a usage history of a service provided by each of a plurality of business entities with a providable incentive service; and
a procedure for, when acquiring a usage history of the service provided by each of the plurality of business entities for a user, determining, by using the rule, an incentive service providable to the user and executing processing related to the determined incentive service.

16. The program according to 15., wherein
the service includes at least two items out of use of a transportation system, purchase of an article, and use of a lodging facility.

17. The program according to 15. or 16., wherein
the incentive service is awarding of a predetermined value to the user, and
the program further causes the computer to execute a procedure for executing awarding of the value to the user.

18. The program according to 17., wherein
the predetermined value is defined in a virtual currency.

19. The program according to any one of 15. to 18., wherein
a token is set to the service, and
the program further causes the computer to execute:
   a procedure for issuing a token for the service, assigning the token to a user, and releasing assignment of the token issued to the user when provision of the service ends; and
   a procedure for determining a usage history of the service for the each user by using a usage history of the token.

20. The program according to 19., wherein
the token is a non-fungible token (NFT).

21. The program according to any one of 15. to 20., further causing the computer to execute:
a procedure for selecting at least one rule out of a plurality of the rules; and
a procedure for determining the incentive service providable to the user by using the selected rule and executing processing related to the determined incentive service.

### REFERENCE SIGNS LIST

1 Service management system
10 Block chain network
20 Node
30 User terminal
40 Wallet
50 Operator
80 Token
100 Service management apparatus
102 Service processing unit
110 Token processing unit
120 Selection unit
210 Service usage history
220 Rule
230 Deposit pool
240 Token usage history information
1000 Computer
1010 Bus
1020 Processor
1030 Memory
1040 Storage device
1050 Input-output interface
1060 Network interface

What is claimed is:

1. A service management apparatus comprising:
at least one memory configured to store instructions; and
at least one processor configured to execute the instructions to:
store, in a storage, a rule associating a usage history of a service provided by each of a plurality of business entities with a providable incentive service; and
when acquiring the usage history of the service provided by each of the plurality of business entities for a user, determine by using the rule, an incentive service providable to the user and executes processing related to the determined incentive service.

2. The service management apparatus according to claim 1, wherein
the service includes at least two items out of use of a transportation system, purchase of an article, and use of a lodging facility.

3. The service management apparatus according to claim 1, wherein
the incentive service is awarding of a predetermined value to the user, and
wherein the at least one processor is further configured to execute the instructions to
execute awarding of the value to the user.

4. The service management apparatus according to claim 3, wherein
the predetermined value is defined in a virtual currency.

5. The service management apparatus according to claim 1, wherein
a token is set to the service,
wherein the at least one processor is further configured to execute the instructions to
issue a token for the service, assign the token to a user, and release assignment of the token issued to the user when provision of the service ends, and
determine a usage history of the service for the each user by using the usage history of the token.

6. The service management apparatus according to claim 5, wherein
the token is a non-fungible token (NFT).

7. The service management apparatus according to claim 1, further comprising
wherein the at least one processor is further configured to execute the instructions to:
select at least one rule out of a plurality of the rules; and,
use the selected rule.

8. A service management method comprising, by a service management apparatus:
storing, in a storage unit, a rule associating a usage history of a service provided by each of a plurality of business entities with a providable incentive service; and,
when acquiring the usage history of the service provided by each of the plurality of business entities for a user, determining, by using the rule, an incentive service providable to the user and executing processing related to the determined incentive service.

9. A non-transitory computer-readable storage medium storing a program for causing a computer to execute:
a procedure for storing, in a storage unit, a rule associating a usage history of a service provided by each of a plurality of business entities with a providable incentive service; and
a procedure for, when acquiring the usage history of the service provided by each of the plurality of business entities for a user, determining, by using the rule, an incentive service providable to the user and executing processing related to the determined incentive service.

10. The service management method according to claim 8, wherein
the service includes at least two items out of use of a transportation system, purchase of an article, and use of a lodging facility.

11. The service management method according to claim 8, wherein
the incentive service is awarding of a predetermined value to the user, and
the method, by the service management apparatus, further comprises
executing awarding of the value to the user.

12. The service management method according to claim 8, wherein
a token is set to the service,
the method, by the service management apparatus, further comprises:
issuing a token for the service, assigning the token to a user, and releasing assignment of the token issued to the user when provision of the service ends; and
determining a usage history of the service for the each user by using the usage history of the token.

13. The service management method according to claim 12, wherein
the token is a non-fungible token (NFT).

14. The service management method according to claim 8, further comprising:
selecting at least one rule out of a plurality of the rules; and
using the selected rule.

15. The non-transitory computer-readable storage medium according to claim 9, wherein
the service includes at least two items out of use of a transportation system, purchase of an article, and use of a lodging facility.

16. The non-transitory computer-readable storage medium according to claim 9, wherein
the incentive service is awarding of a predetermined value to the user, and
the program causes the computer to execute
a procedure for executing awarding of the value to the user.

17. The non-transitory computer-readable storage medium according to claim 9, wherein
a token is set to the service, and
the program causes the computer to execute;
a procedure for issuing a token for the service, assigning the token to a user, and releasing assignment of the token issued to the user when provision of the service ends; and
a procedure for determining a usage history of the service for the each user by using the usage history of the token.

18. The non-transitory computer-readable storage medium according to claim 17, wherein
the token is a non-fungible token (NFT).

19. The non-transitory computer-readable storage medium according to claim 9, wherein the program causes the computer to execute:
a procedure for selecting at least one rule out of a plurality of the rules; and
a procedure for using the selected rule.
